(19) United States
(12) Patent Application Publication
(10) Pub. No.: US 2024/0258877 A1
(43) Pub. Date: Aug. 1, 2024

(54) MECHANICAL ENERGY STORAGE SYSTEM AND ENERGY CONVERSION METHOD

(71) Applicant: Te-Chih CHANG, Taipei City (TW)

(72) Inventor: Te-Chih CHANG, Taipei City (TW)

(21) Appl. No.: 18/404,927

(22) Filed: Jan. 5, 2024

(30) Foreign Application Priority Data
Jan. 31, 2023 (TW) 112103293

(51) Int. Cl. H02K 7/18; H02J 15/00

(52) U.S. Cl. CPC H02K 7/1823; H02J 15/007

(57) ABSTRACT

A mechanical energy storage system and energy conversion method, which uses off-peak or excess electric power to replace potential energy and peak periods of electric usage to release potential energy, whereby the potential energy is converted into electrical energy. The system uses a plurality of weighted balls that can be sequentially replaced and re-looped round for reuse, whereby the potential energy of the weighted balls is increased by being raised through a delivery device during off-peak electric usage. And during peak electric usage, potential energy change in the weighted balls and a lever arm effect is used to activate an energy converter unit, thereby converting the gravitational potential energy into electric energy. The system can be used for purely mechanical energy transfer and storage.

### BACKGROUND OF THE INVENTION

### (a) Field of the Invention

The present invention relates to a mechanical energy storage system and energy conversion method, and more particularly to a storage system and energy conversion method which uses off-peak electric power to replace potential energy and peak period power usage to release potential energy, whereby potential energy is converted into electric energy.

### (b) Description of the Prior Art

In response to the electricity demand at different times of the day and night, the power station delivers different quantities of electricity accordingly. In order to satisfy a sudden power demand at the user end, the power station further delivers a safe quantity of reserve power. If the quantity of reserve power is not fully consumed during the night, it becomes excessive residual power and is needlessly consumed naturally. Night power usage using off-peak power, and in order to disperse the concentrated load of power generation during the day, off-peak electricity consumption is encouraged along with the cost thereof being more favorable.

As for storing and using the remaining excess power from power usage at night, technology is used that feeds back electricity during daytime peak hours, especially battery storage technology. However, such a system uses a large-sized storage battery equipment that comes at a high cost, and after a long period of use, electrochemical reactions weakens the battery's capacity; moreover, there is a risk of explosion.

Therefore, current development in technology is searching for a design with the function to store electricity that avoids using the field of electrochemistry. For example, ENERGY VAULT, a start-up company in Switzerland, uses cement blocks of relatively high mass that are stacked in a manner similar to building blocks in tower-like structures. The cement blocks are raised to increase the potential energy thereof during off-peak hours at night using crane cables, and stacked in tower-like structures. During peak periods of electric consumption, the crane cables suspend the cement blocks and uses the gravitational force thereon to pull the cables downward and produce a potential energy change in the blocks. Accordingly, through linear motion of the steel cables, a torque is generated on a generator to generate electricity. For technical information, please refer to the company YouTube video upload: https://www.youtube.com/watch?v=k3fy1 u7Gj1w (or refer to the website: https://www.energyvault.com/research-development) on the subject of Energy Vault 3D Simulation.

The basic equipment of the above-described system has towering upright pillars (at minute 1:52″ of the video as shown in the attached photo I), the upper ends of which have multiple asynchronous operations and lifting equipment assembled from hoisting cranes that can be moved horizontally (at seconds 0:34″ of the video as shown in the attached photo II). Off-peak power is used to drive each overhead crane and perform grabbing of large cement blocks arranged on the ground surface in advance, which are then lifted upward to build a dry cement stacked tower (at minute 1:32″ of the video as shown in the attached photo Ill), thereby obtaining potential energy through height. During peak electric use times, the lifting equipment is then used to operate in reverse, whereby, within an unit interval, multiple cranes are assigned to asynchronously let down the large cement blocks, the hanging weight and potential energy change in the large cement blocks being used to produce a torque required to generate power through a steel cable indirect drive system. The video simply showing the simulated images when the system generating electricity is in operation, nevertheless, in case by reverse presumption during off-peak electric use period, the images of the lifting equipment in operation should have shown the plural large cement blocks being stacked up by lifting from the ground to accumulate as building blocks in tower-like structures.

The system is a high precision unit and operational program, wherein the exterior structural design and dimensions of each of the large cement blocks must be of high precision during manufacture.

In addition, earthquake zones must be avoided when choosing the base of operations.

During the process of letting down the large cement blocks to generate electricity, there are three speed stages in the lowering speed curve, including an initial lowering speed, a descent process speed, and a deceleration of the large cement blocks before hitting the ground, which causes an uneven driving energy of the feedback generator. Thus, in order to produce stable power, only the energy from the middle part of the lowering speed curve is used during the descent process.

In order for the system to combinatorially produce a stable power generation curve within an operational unit, multiple cranes are required to asynchronously and alternately complement each other.

After lowering the large cement blocks to the ground, motor power is required to raise the steel cables and displace the cranes horizontally, which causes negative effects on the system.

Regarding initialization of the system feedback power, because of the height of the stacked tower, the lowering travel distance of the highest-positioned large cement blocks has a relatively long operating time, and the large cement blocks positioned at the lower level of the tower have a relatively lower stored potential energy; hence, the large cement blocks respectively placed at the upper and lower level of the tower achieve an unequal operating effectiveness when lowered.

Further, the system requires a large area for its base of operations, which is large enough for the multiple large cement blocks to be stacked on the front flat ground surface. Moreover, in order to prevent the tower or supports from toppling over, the area for the base of operations requires the overall height of the supports to be the radius of the circumferential area thereof, thus occupying a substantial amount of ground surface.

System maintenance focuses on rust prevention of the steel cables. The multiple cranes comprise crane tracks, and the upper end of each of the supports is provided with a pivot mechanism for plane angle adjustment to protect operation of the lifting equipment, as well as numerous position fixed point detection and speed sensing units, or electric wires for a video system. Hence, maintaining precise operation and maximum reliability of the system requires a heavy maintenance workload.

Construction of the system requires an extensive safety area and a geologically safe base that must exclude earthquake zones. Moreover, because large cement blocks are stacked to form the tower, further consideration has to be given to the impact of seismic waves. In addition, because of the extremely high tower, the height thereof must be at least the radius of the bottom surface area, with no human activity allowed within this area. Further, because the system operates with extremely low error tolerance, operation requirements are correspondingly very demanding.

### SUMMARY OF THE INVENTION

The main object of the present invention lies in providing a mechanical energy storage system and energy conversion method that utilizes mechanical energy storage, and uses off-peak electric power to replace potential energy and peak period power usage to release potential energy to convert into electric energy. The system uses a plurality of weighted balls that can be sequentially replaced and re-looped round for reuse, whereby during off-peak electric usage or periods when there is an excess in the mains power supply, the potential energy of the weighted balls is increased by being raised through a delivery device. And during peak electric usage or when the mains supply is insufficient, the potential energy of the weighted balls is transformed to activate an energy converter unit to produce electric power feedback.

Another object of the present invention lies in an embodiment of the present invention using a gravitational lever arm effect produced by the weighted balls to produce a torque on a generator of the energy converter unit, wherein a storage space sequentially replenishes the weighted balls, and a stockpile space is used to sequentially receive the weighted balls passing through the energy converter unit, whereafter the weighted balls are sequentially delivered to the storage space by means of a delivery device, thereby transforming the potential energy of the weighted balls by being transported to the higher positioned storage space.

A third object of the present invention lies in configuring an inclined release chute between the storage space and the energy converter unit, and configuring a collection chute between the energy converter unit and the stockpile space, which enable sequentially moving the weighted balls for operation of the system therewith.

A fourth object of the present invention lies in the weighted balls being spherical or round-shaped objects, which are further made from metal material that can come from resources recovered from scrap iron. After prolonged wear and tear of the surfaces, the weighted balls can be melted down and re-produced, providing positive benefits to the environment.

A fifth object of the present invention lies in the basic embodiment of the system of the present invention, wherein the energy converter unit is axially linked to the generator, with at least two receiving units arranged equiangularly around the perimeter of the energy converter unit. Further, the inclined release chute provides a passage between the storage space and the energy converter unit, and the collection chute provides a passage between the energy converter unit and the stockpile space; a plurality of the weighted balls can accordingly be replaced and stored in the storage space and the stockpile space. The weighted balls stored in the stockpile space are sequentially delivered to the storage space using the delivery device, after which the weighted balls are propelled to the energy converter unit. In addition, the system includes an electromechanical control unit which electromechanically controls the system.

A sixth object of the present invention lies in aligning the lower end of the inclined release chute to connect with the receiving units to enable receiving the weighted balls. And the upper end of the collection chute is aligned to connect with the receiving units to enable receiving the weighted balls when released from the energy converter unit, wherein the receiving angle between the receiving unit and the inclined release chute can be precisely aligned mechanically or controlled by an electromechanical device via an electric motor.

A seventh object of the present invention lies in structuring an allocation path between the storage space and the inclined release chute, wherein the allocation path sequentially connects with an array of accumulating channels, the lower terminal end position of which is provided with an outlet, which affords passage to a delivery unit of the inclined release chute.

An eighth object of the present invention lies in structuring the allocation path between the storage space and the delivery device, wherein the allocation path sequentially connects with the array of accumulating channels, the uppermost end position of which is provided with a delivery intersection, which affords passage to a handover outlet of the delivery device.

A ninth object of the present invention lies in structuring a sequencing path between the stockpile space and the collection chute, wherein the sequencing path sequentially connects with an array of stowage channels, the uppermost end position of which is provided with a storage inlet, which affords passage to the lower end of the collection chute.

A tenth object of the present invention lies in linking up the sequencing path aligned with the array of stowage channels to correspond to one side of the delivery device, wherein the lowermost end of the sequencing path is provided with a dispensing outlet, which affords passage to the lower end of the delivery device.

An eleventh object of the present invention lies in enabling the delivery device to operate by moving up and down, the lower end of which is configured with a delivery unit and repelling members corresponding to the position of the dispensing outlet, wherein the repelling members enable activating a holding bar configured on the dispensing outlet.

A twelfth object of the present invention lies in providing the outer side of each of the receiving units with an external inclined side plate at an angle of 80 degrees to the radial line.

A thirteenth object of the present invention lies in the weighted balls being round shaped objects, which are further made from metal material.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 shows a schematic structural view of a system of the present invention.

FIG. 2 shows a schematic view of the system connected to electric power facilities according to the present invention.

FIG. 3 shows a schematic view depicting electromechanical control of the system according to the present invention.

FIG. 4 shows a schematic view depicting operation of the system according to the present invention.

FIG. 5 shows a schematic view depicting operation of an energy converter unit of the present invention.

FIG. 6 shows a schematic view depicting a weighted ball being fed out and shifted according to the present invention.

FIG. 7 is an operational side view of a storage space dispensing the weighted balls according to the present invention.

FIG. 8 is an operational three-dimensional schematic view of a storage space dispensing the weighted balls according to the present invention.

FIG. 9 is a front schematic view of an allocation path propelling the weighted balls according to the present invention.

FIG. 10 is an operational front schematic view of the storage space replacing the weighted balls according to the present invention.

FIG. 11 is a front schematic view of a sequencing path sorting the weighted balls according to the present invention.

FIG. 12 is an operational schematic view of a delivery device sequentially loading the weighted balls according to the present invention.

FIG. 13 is another schematic view depicting operation of the delivery device of the present invention.

### DETAILED DESCRIPTION OF THE PREFERRED EMBODIMENTS

The present invention discloses a mechanical energy storage system and energy conversion method for converting electrical energy by using off-peak electric power to replace potential energy and peak periods to release potential energy. The system uses a plurality of weighted balls that can be sequentially replaced and re-looped round for reuse, whereby a change in potential energy of the weighted balls activates an energy converter unit for conversion into electric power. The system uses purely mechanical means for energy transformation and storage.

The following description of the drawings details the system and energy conversion method of the present invention.

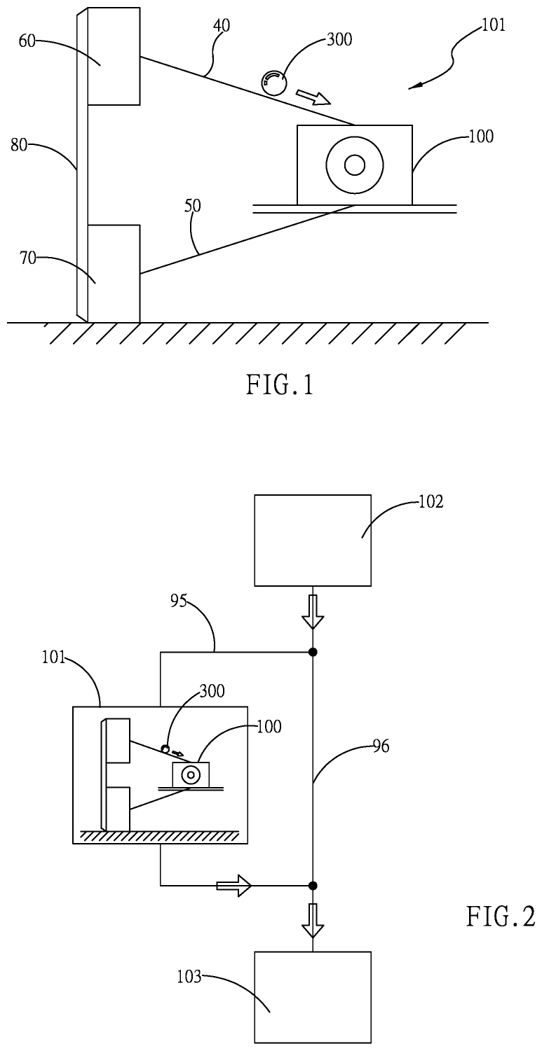

Referring first to FIG. 1, which shows an energy storage system 101 that includes an energy converter unit 100. Weighted balls 300 acquire a gravitational potential energy when in a storage space 60, and the potential energy from the weighted balls 300 is used to activate the energy converter unit 100, after which the weighted balls 300 are collected and stored in a stockpile space 70 via a collection chute 50. The gravitational force of the weighted balls 300 and a lever arm effect are used to produce a torque that activates the energy converter unit 100 to generate electric power.

During off-peak periods of electric consumption or periods when its convenient and there is sufficient mains power supply, the weighted balls 300 propelled into the stockpile space 70 are delivered to the high positioned storage space 60 through a delivery device 80, thereby changing the potential energy of the weighted balls 300 ready to be sequentially dispensed from an inclined release chute 40 into the energy converter unit 100 for operation thereof. After the potential energy of each of the weighted balls 300 has been expended, they are returned and stored in the stockpile space 70.

Referring to FIG. 2, which shows a generator end 102 that delivers electricity to a user end 103 through a main line 96, wherein one end of the main line 96 is bypassed to the energy storage system 101 of the present invention through a bypass circuit 95. When the generator end 102 is supplying sufficient electric energy or at off-peak periods of electric consumption, the energy storage system 101 raises the potential energy of the weighted balls 300. And at peak periods of electric consumption or when there is sufficient power load at the generator end 102, then the gravitational potential energy of the weighted balls 300 in the storage space is used to generate electric energy through the energy converter unit 100, and the electric energy is reversed to supplement the electricity requirements at the user end 103 through the main line 96.

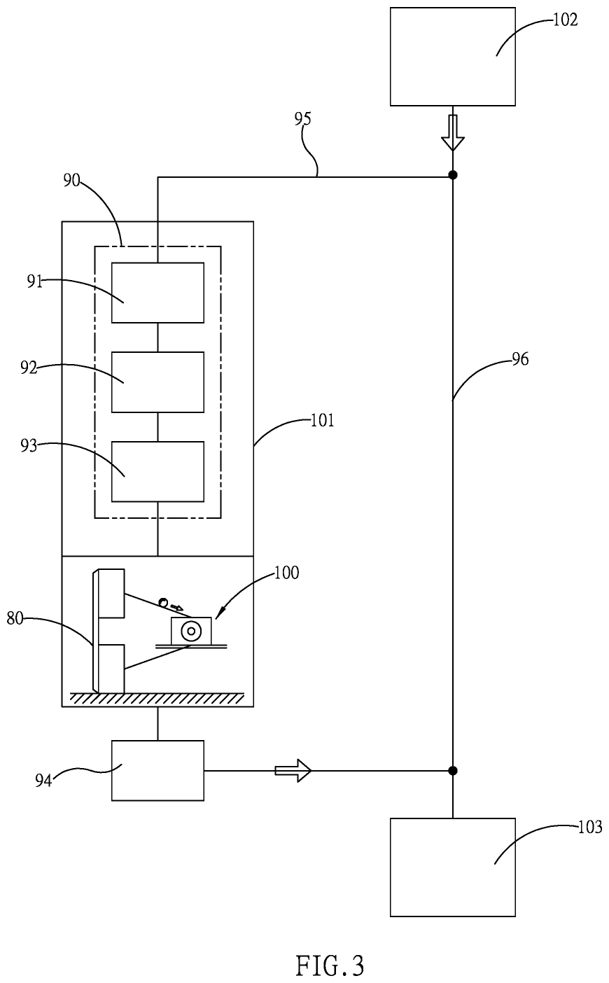

Referring to FIG. 3, the main line 96 connects the generator end 102 to the user end 103, and the main line 96 is bypassed to the energy storage system 101 of the present invention through the bypass circuit 95. The energy storage system 101 includes an electromechanical control unit 90, which comprises a timing device 91, a sensing device 92, and a system control device 93. The timing device 91, the sensing device 92, and the system control device 93 can be exchanged with a computer program, the main purpose of which is to detect the electric energy status of the generator end 102 and determine off-peak or peak periods of electric consumption. Furthermore, it can be determined when there is excess power at the generator end 102, whereupon the system control device 93 instructs the delivery device 80 to start operating (this operational mode is in addition to peak periods), or when the electric power of the main line 96 is insufficient for safety, then the system control device 93 controls the energy converter unit 100 to proceed with generating electric power. The electric power generated then passes through a voltage stabilizer device 94 to supplement the power being delivered to the user end 103 through the main line 96.

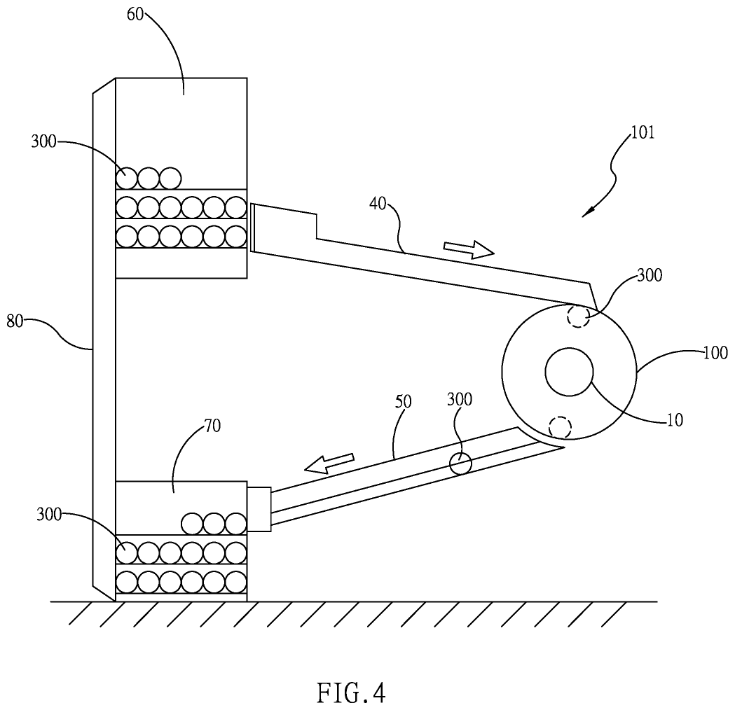

Referring to FIG. 4, which shows the energy storage system 101 mainly comprising the high positioned storage space 60, the energy converter unit 100 installed at a downward drop position thereto, the stockpile space 70 set up below the energy converter unit 100, and a plurality of the weighted balls 300 stored inside the storage space 60. The weighted balls 300 are released down the inclined release chute 40 towards the energy converter unit 100, whereby the gravitational potential energy from the weighted balls 300 produces a torque on a generator 10, activating it to generate electric power. The energy converter unit 100 then transforms the potential energy of the weighted balls 300, after which the weighted balls 300 are released downward towards the stockpile space 70 via the collection chute 50, and sequentially stored therein. The weighted balls 300 accumulate in the stockpile space 70, and based on off-peak periods of electric consumption as described above, the delivery device 80 is instructed to sequentially deliver the weighted balls 300 to the storage space 60, where they are sequentially stored therein. After the storage space 60 is sufficiently stored with the weighted balls 300, or after the stockpile space 70 has been depleted of the weighted balls 300, then the delivery device 80 stops operating, and the energy storage system 101 enters a standby state. The above-mentioned weighted balls 300 are round shaped objects or round blocks, which can be made of metal. The metal can be obtained from a mixture of scrap metal with similar properties, which can be repeatedly recycled and remanufactured into the weighted balls 300 after wear and tear thereof.

The above-described inclined release chute 40 and the collection chute 50 can have any surface that enables rolling the weighted balls 300 providing that the surface does not interfere therewith, and can be laid with shock absorbing sheet material, such as elastic rubber sheet, which can absorb rolling vibrations and also dampen noise.

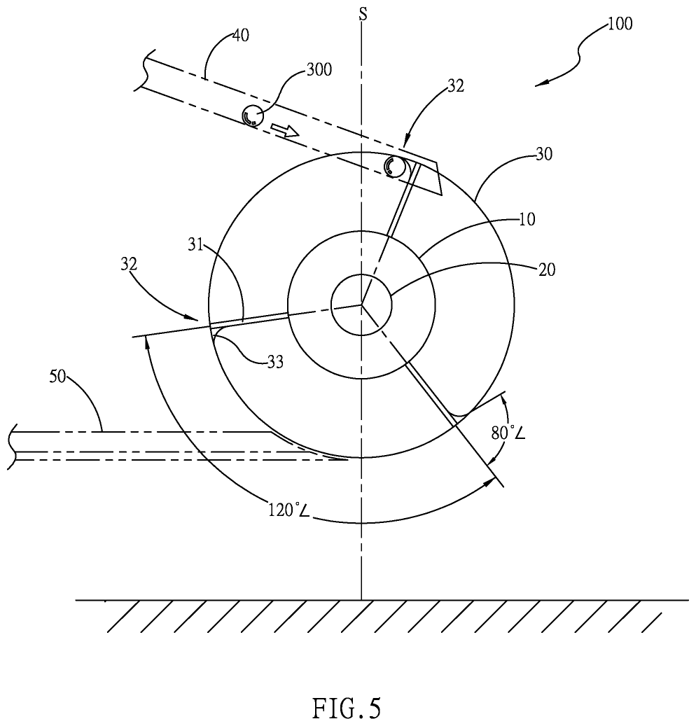

Referring to FIG. 5, which shows the operational mode of the energy converter unit 100, and because the system is mechanical, there exists static friction within the mechanism, thus, an activating device 20 is connected to the axle center of a driven wheel 30. The activating device 20 serves to overcome the static friction during electric power generation, and can also correct the operating angle of the system, enabling aligning receiving units 32 to receive the incoming weighted balls 300.

The activating device 20 activates a generator 10 synchronously linked thereto, after which the generator 10 and the driven wheel 30 coaxially acquire a torque, which produces rotational inertia that drives the receiving units 32 to rotate.

A plurality of radial connecting rods 31 are equiangularly arranged inside the radial surface of the driven wheel 30, to increase the construction strength of the system or simplify the structural configuration.

An external inclined side plate 33 is provided on the outer side of each of the receiving units 32, wherein the external inclined side plate 33 forms an eighty degree angle with the radial connecting rod 31. The eighty degree angle was the test angle for the mechanism of the present invention, however, with different materials or masses, or different mechanism dimensions, the operating system will produce different angular positioned working forces, thus, the angle can be adjusted accordingly. The angle mainly enables the driven wheel 30 to maintain holding the weighted balls 300 during the rotating process of the receiving units 32. At least two of the receiving units 32 are arranged equiangularly within the energy converter unit 100, or, as shown in FIG. 5, three of the receiving units 32 are arranged at equal angles of 120 degrees. The gravitational potential energy of the weighted balls 300 is distributed according to the direction of gravity, and clearly occurs at angular positions from one o'clock to five o'clock. In particular, the angular position at three o'clock produces a maximum torque effect to drive the generator 10, after which the weighted ball 300 follows along with the slope of the external inclined side plate 33 and drops into the inlet of the collection chute 50.

The weighted balls 300 are sequentially fed into the energy converter unit 100 from the inclined release chute 40, and the frequency of feeding depends on the timing when the receiving units 32 have rotated to appropriate receiving angles. The rotational speed of the driven wheel 30 can be low, the function of which is to reduce the quantity of the weighted balls 300 being fed into the energy converter unit 100.

In trial runs of the energy converter unit 100 of the present system producing satisfactory torque, power generation, and operation, and in a trial operating rotational speed of two revolutions per second, only six of the weighted balls 300 needed to be sequentially fed into the energy converter unit 100 to drive the electric generator 10 and generate electric power, meaning the rotational speed of the driven wheel 30 is low. Because the generator 10 has specific rotational speed requirements according to electric power generation specifications, then a rotational speed adjustment device, such as a commonly used transmission (not shown in the drawings), installed between the driven wheel 30 and the generator 10 serves as an indirect power series connection.

The gravitational potential energy from the weighted balls 300 produces a torque on the driven wheel 30 of the energy converter unit 100; however, the torque has diminished and weakened after the angle position of five o'clock, and there is no clear existence of any available torque just before the angle position of six o'clock, thus the weighted balls 300 are transferred to the collection chute 50 for collection thereof.

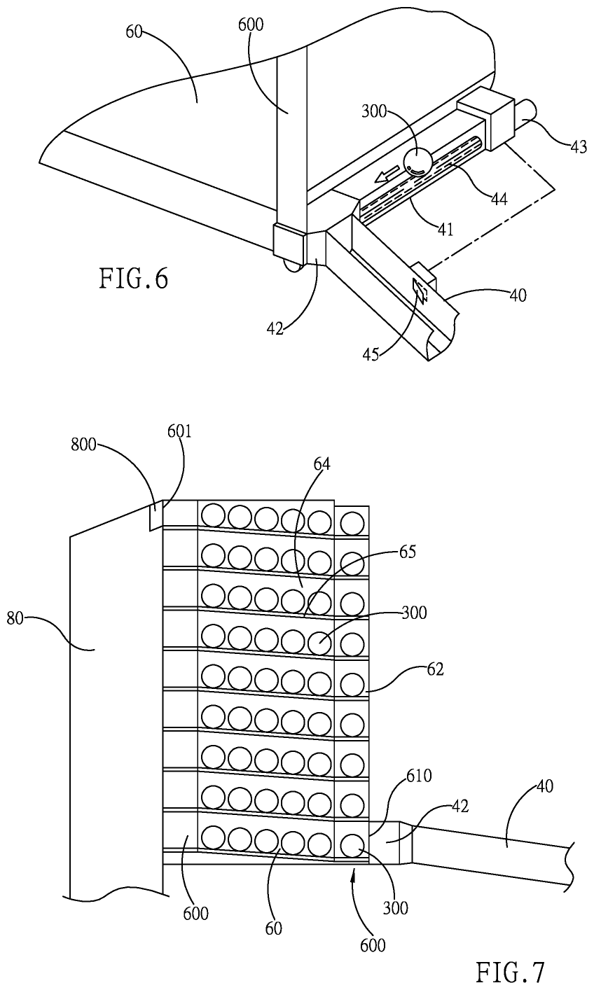

Referring to FIG. 6, which shows an embodiment of a feed mechanism of the present invention, a description of which follows. The feed mechanism can be designed in a plurality of ways, the basic requirements being that the interior of the storage space 60 can sequentially store a plurality of the weighted balls 300, and that the weighted balls 300 can be sequentially passed on to a delivery unit 42 through an allocation path 600 to be allocated toward the inclined release chute 40.

At the end of the allocation process of the weighted balls 300, the weighted balls 300 are sequentially dispensed on the inclined release chute 40 to slide down thereon; or the weighted balls 300 are sequentially propelled and fed into the delivery unit 42 through a propel unit 41. The delivery frequency of the weighted balls 300 relies on the use of a drive device 43 to drive a screw rod 44, which at fixed times pushes out and passes on the weighted balls 300 to the inclined release chute 40 through the delivery unit 42. The driving operation of the drive device 43 requires the wastage of energy; however, the power required will result in different power dissipation depending on different masses of the weighted balls 300. The driving operation of the drive device 43 can use any mechanistic relay card system, such as the kinetic force from the weighted balls 300 sliding down the inclined release chute 40 contacting a toggle member 45, which produces a swivel movement force that activates the screw rod 44 to rotate, thereby achieving a dispensing time relay function for dispensing the weighted balls 300.

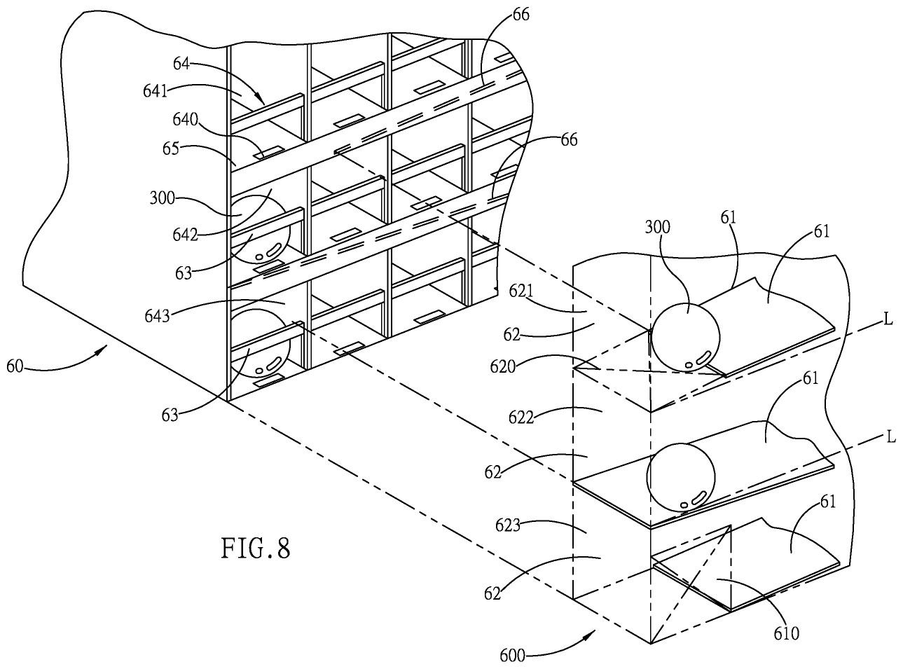

Referring to FIGS. 7 and 8, the storage space 60 is combined with the allocation path 600 so as to correspond to the direction of the inclined release chute 40. The interior of the storage space 60 has a plurality of accumulating channels 64 configured in a multi-level array to provide sequential dispensing of the weighted balls 300. The longitudinal space of each of the accumulating channels 64 enables storing a plurality of the weighted balls 300.

The bottom of each of the accumulating channels 64 is a forward inclined surface 65, which slopes downward and positioned corresponding to a sequencing path 62 of the allocation path 600. An outlet 610 is provided at a corner position at the lower end output direction of the allocation path 600. The delivery unit 42 affords passage to the inclined release chute 40.

The storage space 60, corresponding to one end of the delivery device 80, equipped with the rear side allocation path 600 (as shown on the left side of FIG. 7) has a delivery intersection 601 provided at the uppermost end thereof, which uses the same mechanism as at the lowermost end, whereby the delivery intersection 601 corresponds to a handover outlet 800 of the delivery device 80 to receive the weighted balls 300 delivered by the delivery device 80. That is, the delivery device 80 upwardly raises the weighted balls 300 from the stockpile space 70, which then pass through the handover outlet 800 and drop into one end of the sequencing paths 62 at the uppermost level of the allocation path 600 from the delivery intersection 601. The gravitational potential energy of the weighted balls 300 cause them to roll in the direction of the lowermost level aligned accumulating channel 64. After each of the lowermost level accumulating channels 64 are filled, the weighted balls 300 then fill up the upper level accumulating channels 64 according to the specifications of the sequencing paths 62.

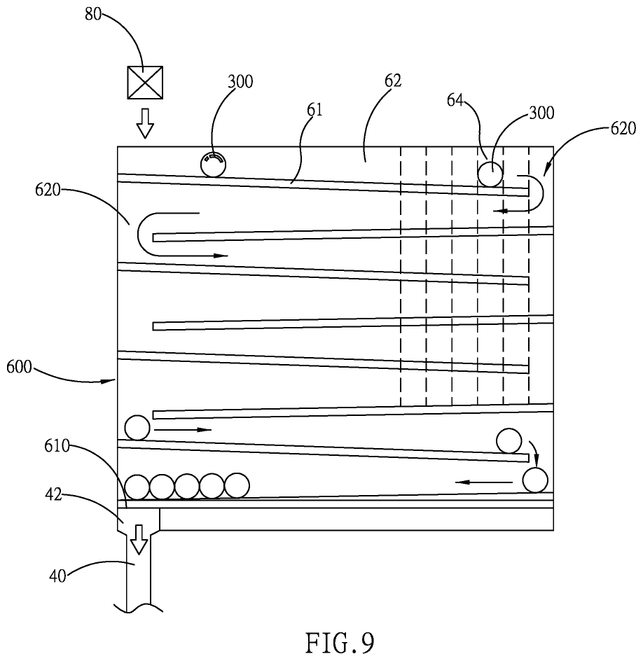

Referring to FIGS. 8 and 9, regarding the downward replenishment method of the weighted balls 300, the interior of the storage space 60 is divided into an array configuration of a plurality of the accumulating channels 64, and each of the accumulating channels 64 is controlled by the opening and closing of a latch 63. The opening and closing of each of the latches 63 is directed by a detection unit 640 associated therewith. The detection unit 640 can be a photoelectric pressure switch or a mechanical weighted pressure switch, which is pressed down by the weight of the weighted balls 300, thereby determining whether or not there are any of the weighted balls 300 in the accumulating channel 64, and directing the latch 63 to block or release the weighted balls 300.

Regarding the operating state of the release of the weighted balls 300 one by one into the allocation path 600, first, the weighted balls 300 in the interior of the storage space 60 are forced forward by the sloping effect of the forward inclined surfaces 65 of the accumulating channels 64. The latch 63 blocks the weighted balls 300 until the entire longitudinal space of the accumulating channel 64 is full of the weighted balls 300, wherein the opening of each of the accumulating channels 64 is aligned with the corresponding level sequencing path 62 of the allocation path 600. Each of the sequencing paths 62 is subjected to the alternate sloping state of inclined tracks 61, which causes a downward sliding movement of the weighted balls 300 by passing through turnaround drop openings 620 following the upper and lower sequencing paths 62, sequentially rolling and winding round toward the lowermost level sequencing path 62 to arrive at the outlet 610. The upper and lower level inclined tracks 61 respectively make reverse angle descents with a horizontal line L, causing the sequencing paths 62 to form a Z-shaped sloping and sequencing region.

The weighted balls 300 positioned in the storage space 60 are released toward the allocation path 600, whereby, first, the upper level accumulating channel 64 releases the weighted balls 300, which are delivered to the outlet 610 through the allocation path 600. After the weighted balls 300 are cleared from the interior of the upper level accumulating channel 64, then all of the stored weighted balls 300 of the adjacent lower level, horizontally arranged accumulating channel 64 begin to be released in a lateral tilting sequence through the respective latches 63 associated therewith in a left, right relay.

The horizontally adjacent accumulating channel 64, starting at the highest end, gradually opens and sequentially releases the weighted balls 300 into the allocation path 600 according to the sloping direction of the sequencing path 62 of the allocation path 600.

The weighted balls 300 roll into a corresponding upper sequencing path 621 and a middle sequencing path 622 of the allocation path 600 from the upper level accumulating channel 64. The weighted balls 300 rolling through the turnaround drop openings 620 and dropping into the middle sequencing path 622, then finally reaching a lower sequencing path 623, ready to be fed out from the outlet 610.

After an upper accumulating channel 641 positioned at the upper level drops the final weighted ball 300, the operation is then handed over to a middle accumulating channel 642 at the next level corresponding to the middle sequencing path 622 of the allocation path 600. Then the weighted balls 300 are fed out the left end of the sloping uppermost point of the middle sequencing path 622 and pass along the inclined track 61 of the middle sequencing path 622, downwardly rolling along the incline before finally being subjected to the sloping effect of the lower sequencing path 623 to roll down to the outlet 610. After the weighted balls 300 are completely cleared from being fed from the left to the right of the middle accumulating channel 642, then the other end of a lower accumulating channel 643 sequentially releases the weighted balls 300 to the outlet 610.

Between the plurality of accumulating channels 64 arranged in an array configuration inside the storage section 60, the plurality of inclined tracks 61 are arranged obliquely relative to the allocation path 600, and form a height split distance. The side of each of the inclined tracks 61 of the allocation path 600 has abutment lines 66 on the opening front of the storage space 60.

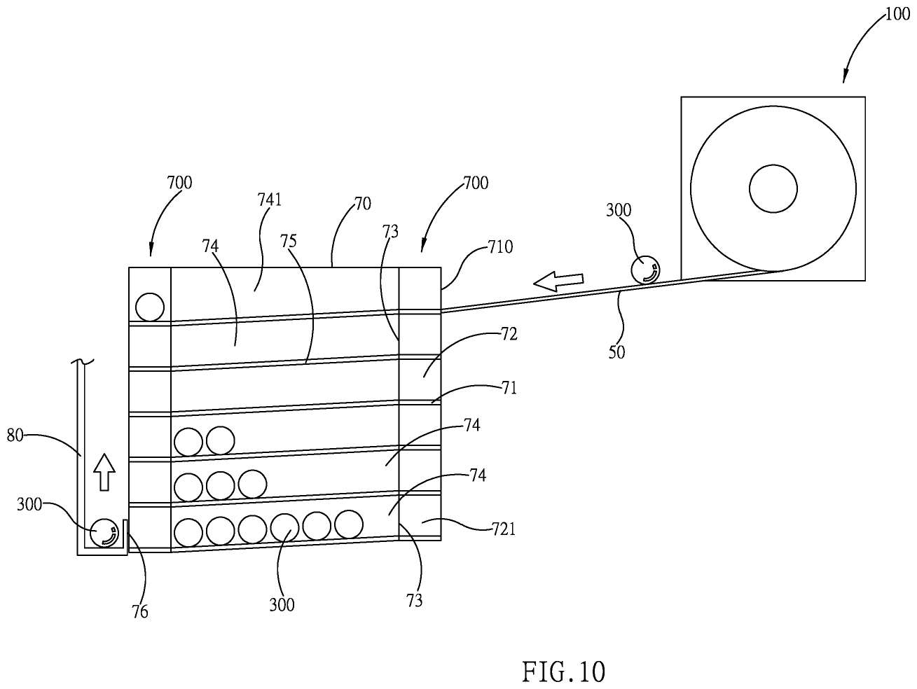

Referring to FIG. 10, which shows the interior of the stockpile space 70 of the system, wherein a plurality of the weighted balls 300 are sequentially stored, and the collection chute 50 provides a passageway between the stockpile space 70 and the energy converter unit 100. The collection chute 50 is indirectly joined to a sequencing path 700 (the concept behind the structural configuration of the stockpile space 70 and the sequencing path 700 is the same as that of the storage space 60 and the allocation path 600 of FIG. 8, wherein both have a plurality of upper and lower levels and left and right adjacent channels: accumulating channels 64 in the storage space 60, and stowage channels 74 in the stockpile space 70, with the bottom of each of the stowage channels 74 having a backward inclined surface 75). A storage inlet 710 is provided between the uppermost level sequencing path 700 and the collection chute 50 that enables the weighted balls 300 to be channeled therethrough. After the weighted balls 300 are channeled into the storage inlet 710, a sequencing channel 72 at the uppermost level of the sequencing path 700 enables the weighted balls 300 to sequentially drop into a lowermost sequencing path 721 at the lowermost level by means of the sloping effect of inclined tracks 71, whereupon they enter and are sequentially accumulated in the lowermost level stowage channel 74 through a corresponding passage opening 73.

The weighted balls 300 then enter the interior of the next empty stowage channel 74 and sequentially stored therein using the sloping effect of the backward inclined surface 75 thereof. The weighted balls 300 are accordingly transferred level by level to the uppermost level stowage channel 74, thereby filling the interior of the stockpile space 70 from the bottom upwards with the weighted balls 300, ready to be handed over to the delivery device 80 for further operation thereof. Upon operation of the delivery device 80, the weighted balls 300 are dropped into the delivery device 80 through a dispensing outlet 76 at the lower corner of the rear side of the sequencing path 700.

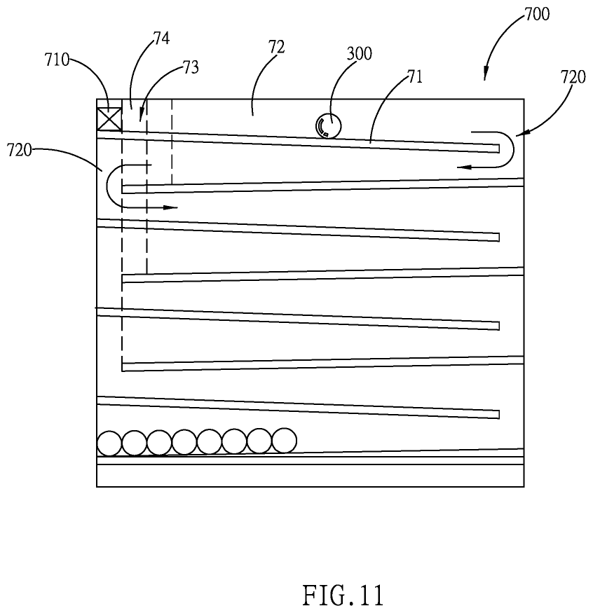

To supplement the description of the front side sequencing path 700, referring to FIG. 11, the structural concept is the same as that of the allocation path 600 shown in FIG. 8, and is configured with the sloping inclined tracks 71, whereby the weighted balls 300 pass through turnaround drop openings 720 to travel from the upper to the lower levels. The weighted balls 300 are channeled into the storage inlet 710, and sequentially follow the sloping effect of the inclined tracks 71, rolling round the turnaround drop openings 720 to finally reach the lowermost level sequencing path 72, where the weighted balls 300 are ready for delivery to the rear side.

Referring to FIG. 10, when the delivery device 80 is ready for operation, the dispensing outlet 76 at the rear side of the sequencing path 700 releases the weighted balls 300 one by one into the delivery device 80 to be delivered upward, thereby changing the potential energy of the weighted balls 300.

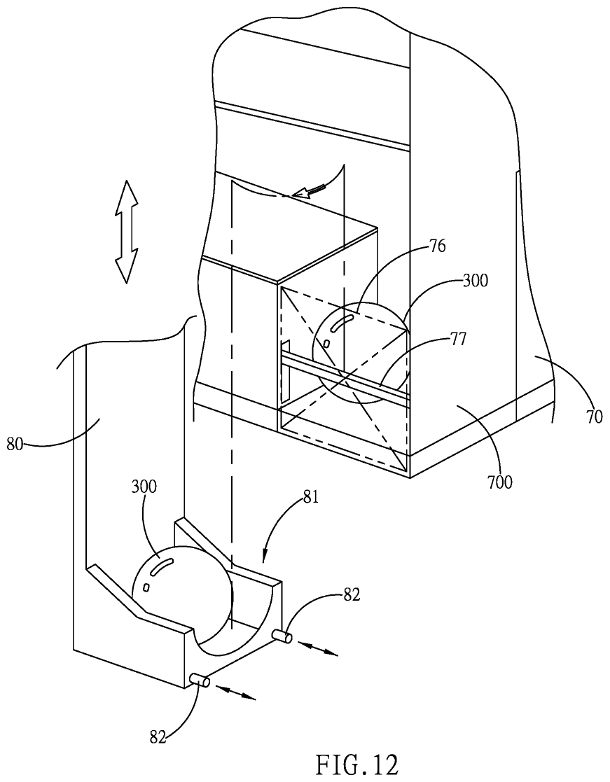

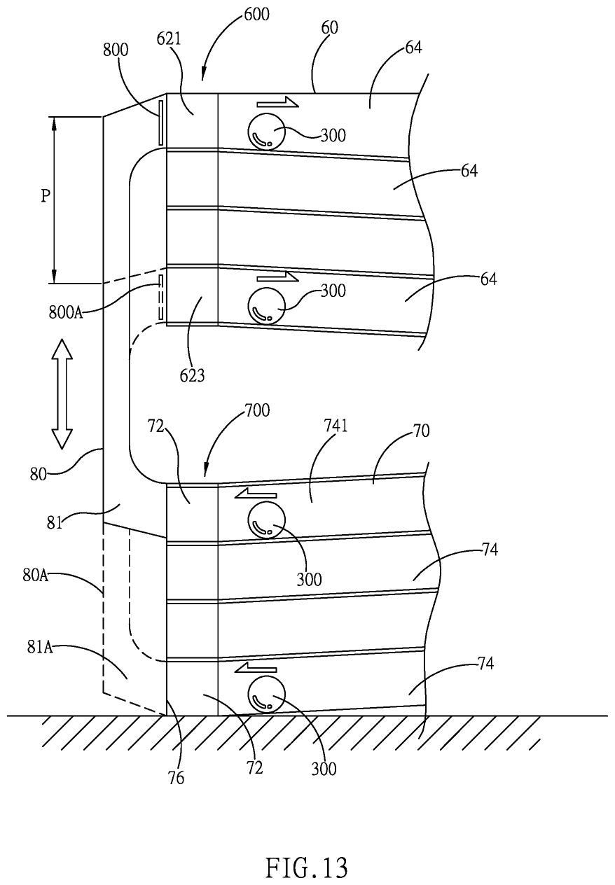

Referring to FIGS. 12 and 13, the sequencing path 700 is indirectly linked between the stockpile space 70 and the delivery device 80, and the sequencing path 700 is provided with the dispensing outlet 76 at a fixed corner position corresponding to the delivery device 80 for handover of the weighted balls 300 thereto. The rolling effect of the weighted balls 300 rolling down the inclined tracks enable them to roll into a delivery unit 81 of the delivery device 80 through the dispensing outlet 76. The delivery unit 81 functions with an up-and-down movement mechanism, whereby after receiving the weighted balls 300, the delivery unit 81 upwardly delivers them to the storage space 60. The weighted balls 300 are dispensed into the delivery unit 81 from the interior of the sequencing path 700 through the dispensing outlet 76 and raised upward, and are replenished with the weighted balls 300 dropping downward from upper levels, which is the same as the operational concept of the allocation path 600 as shown in FIG. 8.

During the time when the delivery unit 81 of the delivery device 80 has disengaged from the dispensing outlet 76 and is transporting the weighted ball 300 upwards, the weighted ball 300 located at the first sequenced position of the dispensing outlet 76 is blocked by a corresponding holding bar 77. When the delivery device 80 has completed its upward transportation and delivery of the weighted ball 300, the delivery device 80 travels downward for repositioning thereof, whereupon repelling members 82 provided on the delivery unit 81 are used to press down on the holding bar 77 using a mechanical locking method, causing the corresponding holding bar 77 to pull back and allow the weighted ball 300 to enter the delivery unit 81. The delivery unit 81 once again upwardly transports the weighted ball 300, at which time the repelling members 82 unlock the intervening force on the corresponding holding bar 77, thereby enabling the holding bar 77 to elastically reposition and once again block the subsequent weighted ball 300 behind the holding bar 77.

Referring to FIG. 13, which shows the storage space 60 and the stockpile space 70 configured at corresponding upper and lower heights, wherein the delivery device 80 is responsible for upwardly delivering the weighted balls 300 positioned in the stockpile space 70 to the storage space 60. In order to save on energy expended by the delivery device 80, the height of the upward delivery operation of the weighted balls 300 by the delivery device 80 can be adjusted.

The method to adjust the delivery height of the delivery device 80 is by supporting the entire front with a general auxiliary raising mechanism (not shown in the drawings) to change the displacement height P. The handover outlet 800 is raised along with the delivery unit 81, and as shown in FIG. 3, the handover outlet 800 is displaced to the highest position thereof through a displacement height P, whereupon the handover outlet 800 is positioned at the corresponding uppermost level of the storage space 60 and aligned with the opening position of the upper sequencing path 621, and the lower end of the delivery unit 81 aligns with the corresponding opening position of the sequencing path 72 of a stowage channel 741 at the uppermost level of the stockpile space 70. Basically, the height travel distance of the delivery device 80 can be reduced.

The delivery unit 81 acquires the weighted ball 300 in the uppermost level stowage channel 741 from the highest positioned sequencing path 72 of the stockpile space 70, and delivers the weighted ball 300 upward, and delivers the weighted ball 300 through the handover outlet 800 into the corresponding upper sequencing path 621 of the uppermost level accumulating channel 64 of the storage space 60, thereby enabling replenishing the weighted balls 300 in the uppermost level accumulating channel 64. After filling the uppermost level accumulating channel 64 with the weighted balls 300, the positional height of the delivery device 80 is moved downward, causing the handover outlet 800 to correspond to the next level accumulating channel 64, at which time the delivery unit 81 is docked at the height of the next uppermost level stowage channel 741 of the next level stowage channel 74. Sequentially lowering the delivery device 80 to the lowermost position thereof forms the state of the delivery device 80A shown in FIG. 13, at which time the delivery unit 81A is docked at the lowermost positioned stowage channel 74 of the stockpile space 70. The sequencing path 700 acquires the weighted ball 300 causing it to enter the delivery unit 81A, which is then delivered to the lowermost level accumulating channel 64 of the storage space 60 from a handover outlet 800A by passing through the lower sequencing path 623, thereby replenishing and filling the lowermost level accumulating channel 64.

Using the upward and downward displacement of the delivery device 80 enables acquiring the weighted balls 300 from corresponding stowage channels 74 horizontally arranged at different height levels, and delivering the weighted balls 300 to the storage space 60. The multilevel structured accumulating channels 64 of the storage space 60 are accordingly replenished with the weighted balls 300, thereby reducing movement of the displacement height P and saving on energy wastage of the delivery device 80.

The upward and downward displacement of the delivery device 80 can adopt any displacement mechanism, such as a screw rod. Most important is that the mechanism is able to drive the delivery unit 81 to synchronously displace the handover outlet 800 to follow each varying level of the accumulating channels 64 and the corresponding stowage channels 74 of the storage space 60 and stockpile space 70, respectively, and is structured so as to be in a height correspondence relationship.

The above-described order of positional height adjustment of the entire delivery device 80 can be changed to cope with the capacity of the stockpile space 70 or the order of the delivery operation.

The above description of the diagrams regarding the structure and description of the storage space 60, the stockpile space 70, the allocation path 600 and the sequencing path 700 are examples of simple structures; the relevant main design is that the stockpile space 70 is able to stow the weighted balls 300, which can then be raised to the storage space 60 by means of the delivery device 80, to create the requirements to activate the energy converter unit 100. And after the potential energy of the weighted balls 300 has been expended, the weighted balls 300 are one by one guided and received by the structural system of the stockpile space 70. The concepts described above according to the diagrams shown in FIGS. 7 to 11 define the same operating functions for the storage space 60 and the stockpile space 70, so the functional characteristics can be determined simply and clearly by referring to the functional wording for easy understanding.

When the mains supply of electric power is fully satisfied, the system provided by the present invention transforms potential energy, and when there is a large demand for power from the main supply, an energy converter unit is activated to generate power, enabling a feedback system to operate in a purely mechanical manner. Moreover, a storage space and a stockpile space of the system are completely sealed, and thus cope easily with earthquakes. It is an innovative, stable, and practical energy storage method. Furthermore, the system is purely mechanical, using gravitational effects to convert energy, and thus an innovative invention. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A mechanical energy storage system and energy conversion method, comprising:
a stockpile space, the interior of which sequentially stockpiles a plurality of weighted balls;
a delivery device, an end of which connects to the stockpile space;
a storage space, which connects to the other end of the delivery device;
a generator that converts gravitational potential energy from the weighted balls by generating a torque that drives the generator;
the method for storing and converting energy further comprising steps of:
a) replacing gravitational potential energy of the weighted balls at off-peak times of power use, with the delivery device sequentially delivering the weighted balls stored in the stockpile space to the storage space at an upper side of the system;
b) the storage space sequentially downward feeding the weighted balls;
c) an energy converter unit sequentially receiving the weighted balls being fed from the storage space, with the gravitational energy from the weighted balls generating a torque that drives the generator to generate electrical energy;
d) the energy converter unit sequentially returning the weighted balls to the stockpile space at a lower side of the system, retaining the weighted balls in a standby state; releasing potential energy at peak times of power use to convert into electrical energy.

2. The mechanical energy storage and energy conversion method according to claim 1, wherein an inclined release chute is configured between the storage space and the energy converter unit, and a collection chute is configured between the energy converter unit and the stockpile space, which enable sequentially moving the weighted balls for operation of the system therewith.

3. The mechanical energy storage and energy conversion method according to claim 1, wherein the weighted balls are spherical or round-shaped objects, and are further made from metal material.

4. A mechanical energy storage system, wherein the storage system uses off-peak electric power to replace potential energy and peak periods to release potential energy to convert into electric energy, comprising:
the energy converter unit, which is axially linked to the generator, with at least two receiving units arranged equiangularly around the perimeter of the energy converter unit;
the storage space, which is configured with the inclined release chute to provide a passage between the storage space and the energy converter unit:
the stockpile space, which is configured with the collection chute to provide a passage between the stockpile space and the energy converter unit;
a plurality of the weighted balls, which are replaced and stored in the storage space and the stockpile space; the weighted balls are sequentially transported to the energy converter unit;
the delivery device, which sequentially delivers the weighted balls stored in the stockpile space to the storage space; and
an electromechanical control unit, which electromechanically controls the system.

5. The mechanical energy storage system according to claim 4, wherein the lower end of the inclined release chute is aligned to connect with the receiving units to enable receiving the weighted balls, and an upper end of the collection chute is aligned to connect with the receiving units to enable receiving the weighted balls released therefrom.

6. The mechanical energy storage system according to claim 4, wherein an allocation path is structured between the storage space and the inclined release chute, and the allocation path sequentially connects with an array of accumulating channels, the lower terminal end position of which is provided with an outlet, which affords passage to a delivery unit of the inclined release chute.

7. The mechanical energy storage system according to claim 4, wherein the allocation path is structured between the storage space and the delivery device, and the allocation path sequentially connects with the array of accumulating channels, the uppermost end position of which is provided with a delivery intersection, which affords passage to a handover outlet of the delivery device.

8. The mechanical energy storage system according to claim 4, wherein a sequencing path is structured between the stockpile space and the collection chute, and the sequencing path sequentially connects with an array of stowage channels, an uppermost end position of which is provided with a storage inlet, which affords passage to the lower end of the collection chute.

9. The mechanical energy storage system according to claim 4, wherein the sequencing path aligned with the array of stowage channels is linked up to correspond to one side of the delivery device, and the lowermost end of the sequencing path is provided with a dispensing outlet, which affords passage to the lower end of the delivery device.

10. The mechanical energy storage system according to claim 4, wherein the delivery device is enabled to operate by moving up and down, the lower end of which is configured with a delivery unit and repelling members corresponding to the position of the dispensing outlet, wherein the repelling members enable activating a holding bar configured in the dispensing outlet.

11. The mechanical energy storage system according to claim 4, wherein an outer side of each of the receiving units is provided with an external inclined side plate at an angle of 80 degrees to the radial line.

12. The mechanical energy storage system according to claim 4, wherein the weighted balls are round shaped objects or round blocks, which are further made from metal material.

13. The mechanical energy storage system according to claim 4, wherein a height of the entire delivery device is variable to correspond to a height of each stowage channel in the stockpile space.
